(19) United States
(12) Patent Application Publication
(10) Pub. No.: US 2015/0185869 A1
(43) Pub. Date: Jul. 2, 2015

(54) KEYBOARD PROXIMITY SENSING

(71) Applicant: GOOGLE INC., Mountain View, CA (US)

(72) Inventors: Choon Ping Chng, Sunnyvale, CA (US); Kenneth Ryan Loo, San Jose, CA (US); Rachel Nancollas, San Francisco, CA (US)

(21) Appl. No.: 14/584,898

(22) Filed: Dec. 29, 2014

Related U.S. Application Data
(60) Provisional application No. 61/921,695, filed on Dec. 30, 2013.

(51) Int. Cl. G06F 3/023

(52) U.S. Cl. CPC G06F 3/0233

(57) ABSTRACT

In one general aspect, a system can include a key set including a plurality of keys, a membrane keyboard including a plurality of key pads and a plurality of interconnected sensor electrodes, where at least one of the plurality of key pads corresponds to a one of the plurality of keys. The system further includes a feature plate that provides a rigid backing for the membrane keyboard.

### CROSS-REFERENCE TO RELATED APPLICATIONS

This application claims priority under 35 U.S.C. §119(e)(1), to U.S. Provisional Application Ser. No. 61/921,695, filed on Dec. 30, 2013, the entire contents of which are incorporated herein.

### TECHNICAL FIELD

This description generally relates to computing devices. The description, in particular, is related to the use of proximity sensing.

### BACKGROUND

A computing device can provide a user with multiple ways to control the operations of, and to input data to, a computing device. A computing device can include, for example, a touchscreen display, a keyboard, a mouse, a trackpad, a touchpad, a pointing stick, one or more mouse buttons, a trackball, a joystick, and other types of input devices. A user of the computing device can interact with one or more of these input devices when providing input to and/or otherwise controlling the operation of an application running on the computing device. For example, the user may interact with the computing device by making direct contact with (e.g., touching with one or more fingers) the touchscreen.

There are situations, however, where the computing device may remain idle due to lack of user interaction. The computing device may then enter a reduced power and/or operating state. In order for a user to interact again with the computing device, the computing device needs some sort of indication from the user to “wake-up” from its reduced power state. For example, the user may press a key on the keyboard, move and/or press buttons on the mouse, touch and/or tap a trackpad or the touchscreen. All of these inputs to the computing device can “wake-up” the computing device for further input and interactions with the user.

In these cases, a user first needs to provide some sort of input to the computing device in order to have the computing device “wake-up” from its reduced power state. Once the computing device transitions out of its reduced power or sleep state, it can then accept further inputs from the user. The user can perceive this transitioning as a delay in the responsiveness of the computing device to the provided user input.

Thus, a need exists for systems, methods, and apparatus to address the shortfalls of present technology and to provide other new and innovative features. For example, providing systems, methods, and apparatus that can increase the perceived responsiveness of the system to user input is desired.

### SUMMARY

In one general aspect, a system can include a key set including a plurality of keys, a membrane keyboard including a plurality of key pads and a plurality of interconnected sensor electrodes, where at least one of the plurality of key pads corresponds to a one of the plurality of keys. The system further includes a feature plate that provides a rigid backing for the membrane keyboard.

Example implementations may include one or more of the following features. For instance, the membrane keyboard may be coupled to the feature plate. The electric fields may emanate from the plurality of sensor electrodes through the key set. The electric fields may emanate from a plurality of runs connecting the plurality of sensor electrodes. The plurality of interconnected sensor electrodes may detect a proximity of a conductive object with the system by sensing a capacitance of the object. The conductive object may be a human body part. The human body part may be a hand.

In another general aspect, a computing device can include a key set, a membrane keyboard including a plurality of interconnected sensor electrodes, a self-capacitance measurement device, and a non-transitory computer-readable medium having instructions stored thereon, the instructions, when executed by a processor, causing at least one processor of the computing device to perform operations. The operations can include emanating, by the plurality of interconnected sensor electrodes, electrical fields through the key set, sensing, by the plurality of interconnected sensor electrodes, a capacitance, providing, by the plurality of interconnected sensor electrodes, an electrical signal indicative of the sensed capacitance to the self-capacitance measurement device, determining, by the self-capacitance measurement device, a change in a self-capacitance; and performing an action on the computing device based on the determined change in the self-capacitance.

Example implementations may include one or more of the following features. For instance, sensing, by the plurality of interconnected sensor electrodes, a capacitance may include sensing the capacitance of a part of a human body. The part of the human body may be a hand. Performing an action on the computing device may include activating keyboard backlighting. Performing an action on the computing device may include activating a microphone. Performing an action on the computing device may include transitioning the computing device from a sleep or reduced power mode to a full power mode. The computing device may further include a feature plate coupled to the membrane keyboard and a chassis, where the feature plate is not grounded to the chassis.

In yet another general aspect, a method can include emanating, by a plurality of interconnected sensor electrodes included in a membrane keyboard of a computing device, electrical fields through a key set, sensing, by the plurality of interconnected sensor electrodes, a capacitance proximate to the key set, providing, by the plurality of interconnected sensor electrodes, an electrical signal indicative of the capacitance to a self-capacitance measurement device, determining, by the self-capacitance measurement device, a change in a self-capacitance, and performing an action on the computing device based on the determined change in the self-capacitance.

Example implementations may include one or more of the following features. For instance, sensing, by the plurality of interconnected sensor electrodes, a capacitance may include sensing the capacitance of a part of a human body. The part of the human body may be a hand. The action performed on the computing device may include activating keyboard backlighting. The action performed on the computing device may include activating a microphone. The action performed on the computing device may transition the computing device from a sleep or reduced power mode to a full power mode.

The details of one or more implementations are set forth in the accompanying drawings and the description below. Other features will be apparent from the description and drawings, and from the claims.

### BRIEF DESCRIPTION OF THE DRAWINGS

FIG. 1A is a diagram that illustrates an example membrane keyboard that includes sensor electrodes for use in a computing device.

FIG. 1B is a diagram that illustrates an example membrane keyboard that shows the interconnection of sensor electrodes included in the membrane keyboard.

FIG. 2 is a diagram that illustrates layers of a membrane keyboard.

FIG. 3 is a diagram that illustrates an example keyboard assembly for a computing device.

FIG. 4 is a block diagram illustrating example modules included in a computing device.

FIG. 5 is a diagram that illustrates an example of a user interacting with a computing device.

FIG. 6 is a flowchart that illustrates a method of detecting proximity to a computer device.

Like reference symbols in the various drawings indicate like elements.

### DETAILED DESCRIPTION

In some implementations, it is desirable to detect a user's proximity to a keyboard of a computing device before the user presses a key. If the intended action of the user is predicted before the user actually performs the action, the perceived responsiveness of the computing device to the user's action can increase. For example, determining the proximity of a user to the keyboard of the computing device before the user actually even presses a key can cause the computing device to perform one or more actions in preparation for the possibility of a key press. For example, if the computing device is in a reduced power and/or sleep state, the computing device can “wake-up” and be prepared to respond to the first key press or other input to the computing device as soon as the computing device receives the input. In another example, detecting the proximity of a user to a keyboard can turn on a backlighting function for the keyboard. Enabling these and many other features when the computing device detects proximity of the user to the keyboard can increase the perceived responsiveness of the computing device.

A computing device can include a plurality of interconnected sensor electrodes incorporated into a membrane keyboard. The interconnected sensor electrodes can effectively provide a type of “sensor pad” that is built into the membrane keyboard. The interconnected sensor electrodes can be easily included as part of the keyboard fabrication process, adding very little extra cost (if any) and time to the keyboard fabrication. A controller connected to the interconnected sensor electrodes can measure “self-capacitance” as the capacitance of the plurality of the interconnected sensors. Electric fields can emanate from the interconnected sensor electrodes through a set of keys that overlay the membrane keyboard. The keys and the membrane keyboard can be included in a keyboard assembly for the computing device. For example, when a hand of a user moves above, across, or in a detected proximity to the keys, a measured self-capacitance of the interconnected sensor electrodes will increase, indicating the proximity of the user to the keyboard assembly. The computing device can then determine what actions to take based on the detected change in the self-capacitance. Example actions that may be taken by the computing device can include, but are not limited to, turning on or enabling keyboard backlighting, turning on a display device, turning on or enabling one or more microphones (e.g., for use in keyclick noise removal), and power mode transitioning (e.g., from a low power mode (e.g., a sleep mode, a hibernate mode) to a full power mode.

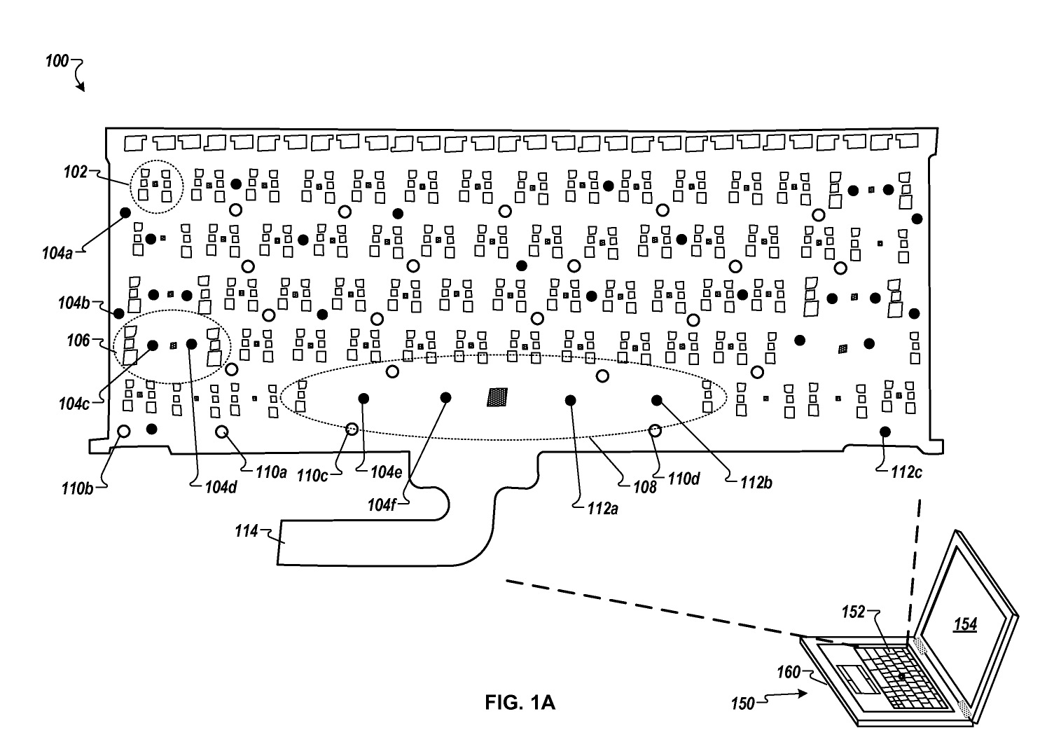

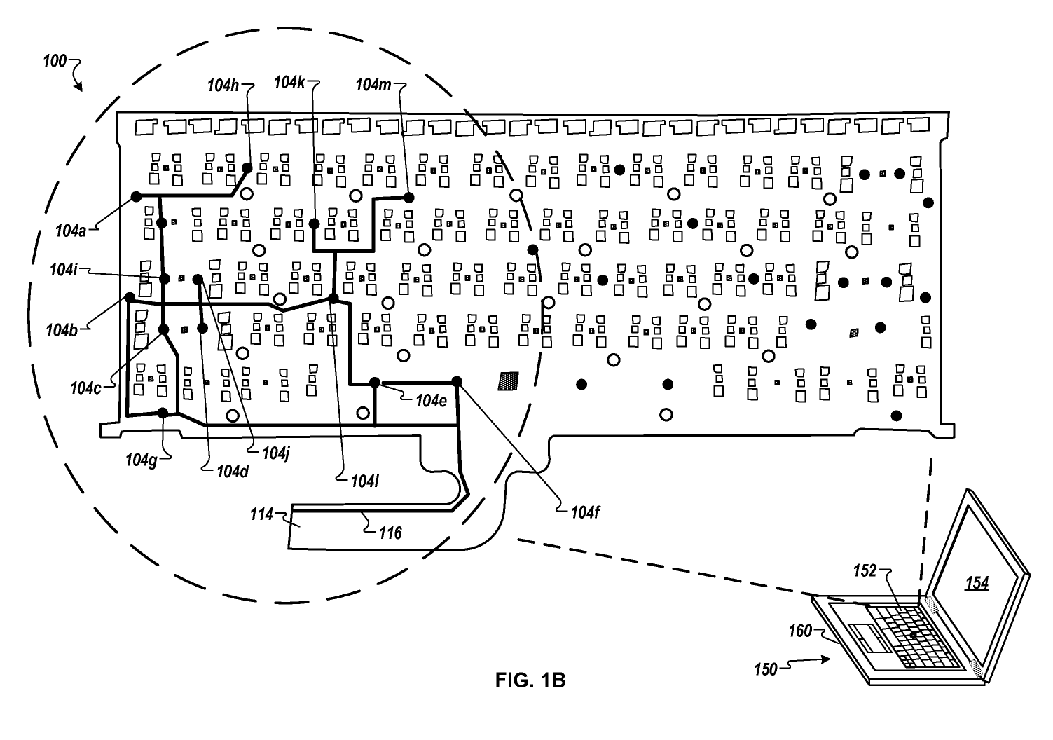

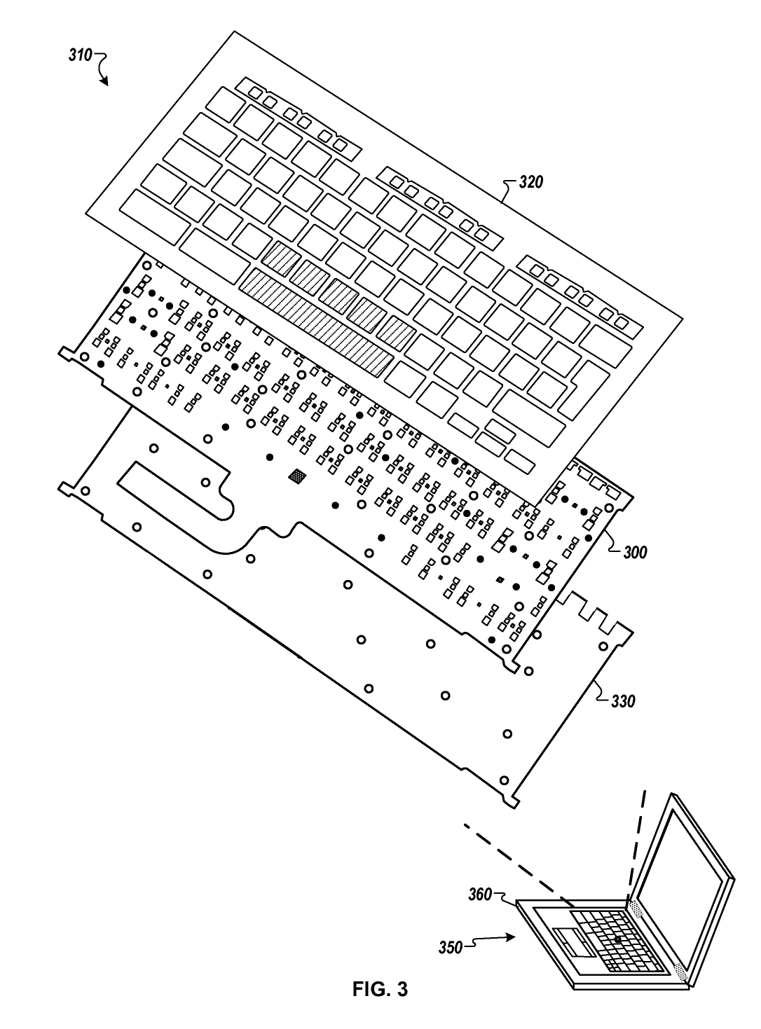

FIG. 1A is a diagram that illustrates an example representation of a membrane keyboard 100 that includes sensor electrodes (e.g., sensor electrodes 104a-f and 112a-c) for use in a computing device 150. The membrane keyboard 100 can be included as part of a keyboard assembly for inclusion in the computing device 150. The keyboard assembly will be described in more detail with reference to FIG. 3. For example, a keyboard 152 can include the membrane keyboard 100.

The computing device 150 includes a housing or chassis 160 that can incorporate the keyboard assembly. In some implementations, the chassis 160 can be coupled to (connected to) ground. In some implementations, coupling (connecting) the keyboard assembly to the chassis 160 can also couple (connect) the keyboard assembly to ground. In some implementations, the keyboard assembly may not be coupled to (connected to) the chassis 160. In these implementations, the keyboard assembly (and the membrane keyboard 100) will not be coupled to (connected to) ground.

The membrane keyboard 100 includes a plurality of keypads (e.g., keypad 102, keypad 106, and keypad 108), a plurality of sensor electrodes (e.g., the sensor electrodes 104a-f and the sensor electrodes 112a-c), and a plurality of mounting holes (e.g., mounting holes 110a-d). The sensor electrodes can be in addition to electrodes included in the plurality of keypads.

The plurality of sensor electrodes can detect the proximity of a human hand (or other parts of a human body) using capacitive sensing. Multiple sensor electrodes can be interconnected to form a single capacitive sensor. In some implementations, all of the sensor electrodes included in the membrane keyboard 100 can be connected forming a single capacitive sensor that encompasses the entire surface of the membrane keyboard 100. As such, a sensor pad can be built into the membrane keyboard 100.

In some implementations, multiple subsets of the plurality of sensor electrodes can be interconnected to form multiple capacitive sensors. For example, each subset of the plurality of the sensor electrodes can define an area or zone of a membrane keyboard (e.g., a left half or left side of the keyboard and a right half or right side of the keyboard). In this example, the computing device 150 can detect proximity of a hand of a user with the right half of the keyboard and can detect the proximity of a hand of a user with the left half of the keyboard separately. The computing device 150 can use this proximity information to detect motion of the hand of the user as the hand moves across the keyboard 152. The motion can be detected as a gesture of the user when interacting with an application running on the computing device 150 (e.g., turning the page of a document displayed in a display area 154 of the computing device 150).

FIG. 1B is a diagram that illustrates an example membrane keyboard 100 that shows the interconnection of sensor electrodes included in the membrane keyboard 100. In the example shown in FIG. 1B, a plurality of sensor electrodes (e.g., sensor electrodes 104a-m) may be included in the membrane keyboard 100. The sensor electrodes can be connected using one or more runs that may also act as sensors. FIG. 1B shows a subset of the sensor electrodes connected for illustrative purposes, however, all sensor electrodes included in the membrane keyboard 100 may be interconnected or different subsets of the sensor electrodes may be interconnected.

In some implementations, a flex connector 114 can provide the signals from the sensor electrodes (e.g., sensor electrodes 104a-m) to a controller, processor, microprocessor, or other type of electronic circuitry included in the computing device 150. For example, the flex connector 114 can connect to a motherboard included in the computing device 150. The signals can be provided to the controller by a run 116 included on the flex connector 114. The controller can identify (measure) a self-capacitance of the interconnected sensor electrodes. The controller can provide a value indicative of the measured self-capacitance change to a processor included in the computing device 150. The processor, based on the received value of the measured self-capacitance change of the interconnected electrodes, can determine if a user (e.g., a hand of the user) is proximate to the keyboard. The processor, based on determining that the user is proximate to the keyboard, can decide to perform one or more actions on the computing device 150. The actions can include, but are not limited to, turning on or enabling keyboard backlighting, turning on or enabling one or more microphones (e.g., for use in keyclick noise removal), and/or transitioning of a power mode (e.g., from a low power mode (e.g., a sleep mode, a hibernate mode) to a full power mode).

For example, when a hand of a user (e.g., one or more fingers, a palm, etc.) is near one or more of the sensor electrodes (e.g., sensor electrodes 104a-m) the self-capacitance of the proximate sensor electrodes change. A controller can measure the self-capacitance of the interconnected sensor electrodes 104a-m. For example, the controller can measure a voltage on a sensor electrode 104a-m with respect to ground and can relate the measured voltage to a capacitance. The controller can then measure a change in the self-capacitance of the interconnected sensor electrodes 104a-m as a change in the current running through the interconnected sensor electrodes 104a-m. The measured change in the self-capacitance can correspond to a change in the proximity of the user (e.g., a hand of the user) with the keyboard 152. For example, an increase in the measured current value can indicate the proximity of the hand of the user. In some implementations, a processor included in the computing device 150 can compare a measured current value to a threshold current value. For example, if the measured current value exceeds the threshold current value, the processor can decide to perform one or more actions on the computing device.

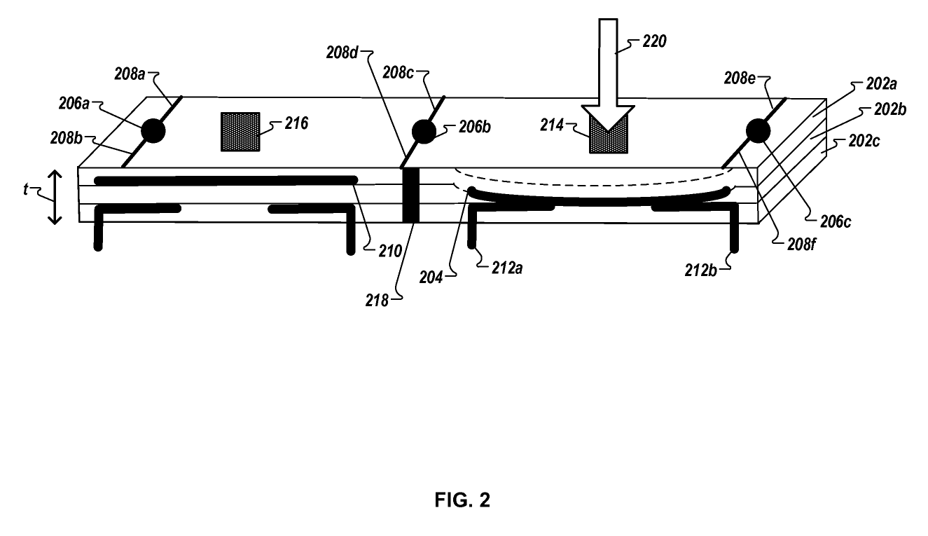

FIG. 2 is a diagram that illustrates layers 202a-c of a membrane keyboard. For example, the membrane keyboard 100 in FIGS. 1A-B can include the layers 202a-c.

A top membrane layer 202a can include a conductive trace 204 and a conductive trace 210. Each conductive trace 204, 210 can be associated with a key 214, 216, respectively. In addition, the top membrane layer 202a can include a plurality of sensor electrodes (e.g., sensor electrodes 206a-c) and sensor traces (interconnections) (e.g., sensor traces 208a-f). A user can press a finger down on a key (e.g., the key 214) on the keyboard in the direction shown by the arrow 220. The pressure can translate to moving (flexing) a portion of the top membrane layer 202a beyond a spacer layer 202b in order to complete contact of the conductive trace 204 with conductive traces 212a-b included in a bottom membrane layer 202c of the membrane keyboard 100. This contact allows current to flow, the detection of which can be interpreted by a computing device as the pressing of the key 214.

For example, a thickness, t, of the membrane keyboard can be a fraction of a millimeter (mm) (e.g., 0.5 mm, 0.75 mm). Sensor electrodes can be included in the membrane keyboard (e.g., on the top membrane layer) without adding any additional thickness to the membrane keyboard. A computing device that incorporates the membrane keyboard can perform proximity sensing without increasing the overall thickness of the membrane keyboard and, as such, the computing device.

In some implementations, the membrane keyboard can include tactile feedback. For example, each key included in the membrane keyboard can include a dome or raised surface. In some implementations, sensors (e.g., sensor electrodes and interconnection lines) can be integrated into/fabricated on a front (top) layer of the membrane keyboard (e.g., sensor electrodes 206a-c and sensor traces 208a-f in the top membrane layer 202a). In some implementations, sensors (e.g., sensor electrodes and interconnection lines) can be integrated into/fabricated on a back (bottom) layer of a membrane keyboard (e.g., the bottom membrane layer 202c). In some implementations, sensors (e.g., sensor electrodes and interconnection lines) can be integrated into/fabricated on both a front (top) layer of the membrane keyboard (e.g., the top membrane layer 202a) and on a back (bottom) layer of a membrane keyboard (e.g., the bottom membrane layer 202c).

FIG. 3 is a diagram that illustrates an example keyboard assembly 310 for a computing device 350. For example, referring to FIG. 1A, the keyboard assembly 310 can be included in the computing device 150 for the keyboard 152.

The keyboard assembly 310 includes a key set 320. The key set 320 can include alphanumeric keys, directional keys, functional keys, and control keys, as non-limiting examples. The key set 320 can also include elements that provide tactile feedback when a user presses a key. The key set 320 can be made from plastic or other non-metallic materials. The keyboard assembly 310 further includes a membrane keyboard 300. The membrane keyboard 300 can be, for example, the membrane keyboard 100 as shown in FIGS. 1A-B.

The keyboard assembly 310 includes a feature plate 330. The feature plate 330 can be a rigid plate that supports the flexible membrane keyboard 300. When a user presses one of the keys in the key set 320, the corresponding key included on the membrane keyboard 300 will move (flex) as shown with reference to FIG. 2. The feature plate 330 can provide the necessary support to the keyboard assembly 310 so that the keyboard assembly 310 does not move (flex) along with the pressed key.

In some implementations, the feature plate 330 can be made of a relatively thin sheet of aluminum or stainless steel. For example, the thickness of the aluminum or stainless steel can be a fraction of a millimeter (mm) (e.g., 0.1 mm, 0.15 mm, 0.5 mm). The thickness of the feature plate 330 can be determined so that the feature plate 330 adds little to the overall thickness of the keyboard assembly 310 while providing the necessary support to the membrane keyboard 300.

In some implementations, the sensor electrodes and the sensor interconnections can be coupled to (connected to) the feature plate 330. In these implementations, the feature plate 330 may not be coupled to (connected to) ground allowing the feature plate 330 to act as part of a circuit that detects self-capacitance. In these implementations, the feature plate 330 can act as a keyboard backplate that is floating (not connected to ground). For example, in these implementations, the feature plate 330 may not be coupled to (connected to) a housing or chassis 360 for the computing device 350.

In some implementations, all of the sensors included in the membrane keyboard can be interconnected and then coupled to (connected to) the feature plate 330. In these implementations, the computing device 350 can detect a proximity of a user (e.g., the hand of a user) when the user (e.g., the hand of the user) is near the keyboard assembly 310. For example, the hand (or both hands) of the user may hover over the keyboard assembly 310. In these implementations, however, the computing device may not detect a specific location of a hand of the user with respect to the keyboard assembly 310 as the entire feature plate 330 is used to detect the self-capacitance.

In some implementations, the feature plate 330 can be divided into two or more zones that correspond to specific keys in the key set 320. For example, the key set 320 can be divided into two groups of keys. The sensor electrodes and interconnections can be implemented on the membrane keyboard 300 to correspond with each group of keys. The feature plate 330 can be divided so that a first zone of the feature plate is connected to sensor electrodes and interconnections that correspond to a first group of keys, and a second zone of the feature plate is connected to sensor electrodes and interconnections that correspond to a second group of keys. The computing device 350 can separately detect the proximity of a user (e.g., a hand of a user) with each portion of the keyboard assembly 310. The computing device 350 can detect, for example, a user moving a hand across the key set 320 from a right side of the keyboard assembly to a left side of the keyboard assembly and from a left side of the keyboard assembly to a right side of the keyboard assembly. An application running on the computing device can translate the detected gesture into an action in an application running on the computing device (e.g., paging through a document a user is viewing on the display area of the computing device). As shown in FIG. 3, the membrane keyboard 300 is located behind the key set 320. Sensors (e.g., sensor electrodes and interconnection lines) included on the membrane keyboard 300 can operate while located behind the key set 320, when the keys included in the key set 320 are made from non-metallic materials (e.g., plastic). Electric fields can emanate from the interconnected sensor electrodes through the keys included in the key set 320. The electric fields can be used to detect human body capacitance (e.g., an item that is conductive and is a dielectric material different from air). In addition, the electric fields can permeate through any other non-metallic portions of the key set 320.

In some implementations, a keyboard assembly can include a membrane keyboard and a feature plate and may not include a key set. For example, an additional overlay layer of the membrane keyboard can be placed/mounted on a front (top) layer of the membrane keyboard. The overlay layer can include graphics that depict/correspond to the related keypad on the membrane keyboard.

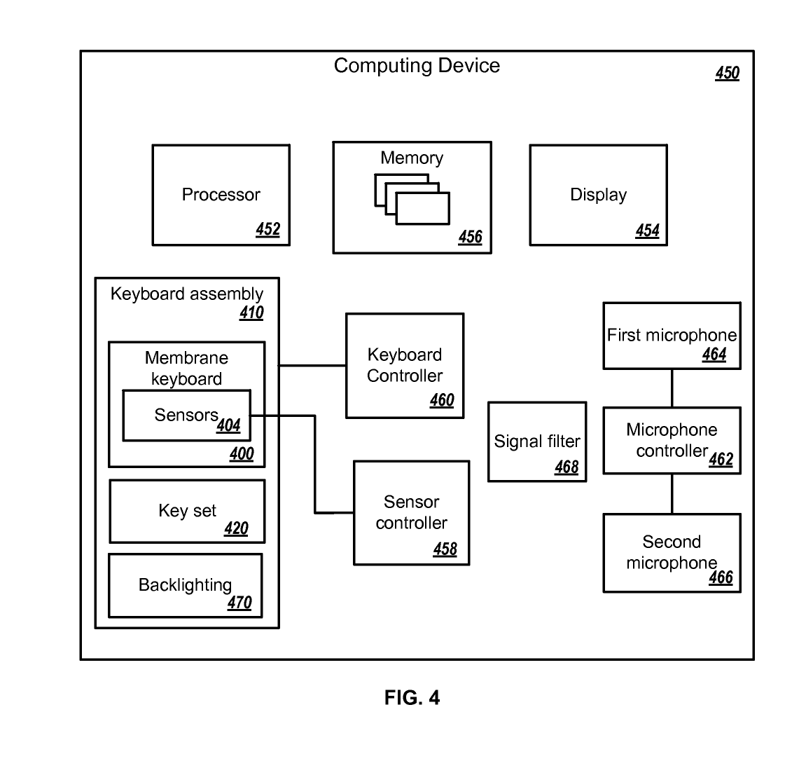

FIG. 4 is a block diagram illustrating example modules and components included in a computing device 450. The computing device 450 includes a keyboard assembly 410 operatively coupled (connected) to a keyboard controller 460. The computing device 450 also includes a processor 452, a memory 456, and a display 454.

The keyboard assembly 410 includes a key set 420, backlighting 470, and a membrane keyboard 400 that includes sensors 404. An example of the keyboard assembly 410 can be the keyboard assembly 310 as shown in FIG. 3. For example, the backlighting 470 can include one or more light emitting diodes (LEDs) or incandescent lights in a plane behind the key set 320. In another example, the backlighting 470 can include one or more electroluminescent panels mounted behind the key set 320. In some implementations, the backlighting 470 can be included behind the key set 320. In some implementations, the backlighting 470 can be included behind the membrane keyboard 300. As shown in FIG. 3, the key set 320 can be placed on top of (above) the membrane keyboard 300 so that when a user presses one of the keys in the key set 320, the corresponding key included on the membrane keyboard 300 will be activated. The keyboard controller 460 can control the operation of the keyboard assembly 410 including the control of the activation/deactivation of the backlighting 470.

The sensors 404 can be a plurality of interconnected sensor electrodes or sensor pads included in the membrane keyboard 400. The sensors 404 can be operatively coupled (connected) to a sensor controller 458 (a self-capacitance measurement device). The sensor controller 458 can measure an amount of current flow through the plurality of interconnected sensor electrodes to establish a steady-state current value when a conductive object (e.g., a human body part (e.g., a hand of a user), a conductive stylus) is not in proximity to any of the sensor electrodes. When a conductive object approaches the plurality of interconnected sensor electrodes (e.g., a hand of a user hovers above a keyboard assembly) the conductive object can couple to the plurality of interconnected sensor electrodes and increase the amount of current drawn through the plurality of interconnected sensor electrodes as the conductive object creates a path to ground. This can result in an increase in the measured self-capacitance of the plurality of interconnected sensor electrodes.

The sensor controller 458 can provide a digital value indicative of the measured amount of current to the processor 452. The processor 452 can compare the received digital value to a threshold value stored in the memory 456. For example, the digital value being greater than the threshold value can indicate that a user (e.g., a hand of the user) is proximate to the keyboard. In some implementations, the sensor controller 458 can provide a digital value indicative of the difference between the measured amount of current and a steady-state current value to the processor 452.

An example of the sensors 404, referring to FIG. 1B, can be the plurality of sensor electrodes 104a-m and sensor traces (interconnections). As shown in FIG. 1B, the plurality of sensor electrodes 104a-m can be interconnected and the signal to/from the interconnected sensor electrodes can be provided from/to a controller (e.g., the sensor controller 458) from the flex connector 114 via the run 116.

In some implementations, the computing device 450 may include active shielding. The active shielding can reduce the effects of external noise and/or interference on the measured self-capacitance of the plurality of interconnected sensor electrodes. The use of active shielding can increase the sensitivity of the measured self-capacitance of the plurality of interconnected sensor electrodes, increasing the accuracy of the detection of a conductive object in proximity to the keyboard. For example, when a human body part (e.g., one or more fingers of a hand of a user, a palm of a hand of a user, one or both hands of a user) is near one or more of the sensors 404 (e.g., one or more of the sensor electrodes 104a-m) the self-capacitance of the proximate sensors change as the amount of current drawn through the proximate sensors increases. The sensor controller 458 can measure a current running through the sensors 404 with respect to ground. The sensor controller 458 can determine the difference between the steady-state current value and the currently measured current value as a measured change in the drawn current (an increase in the drawn current). In some implementations, the processor 452 can compare a value for the measured change in the drawn current to a threshold current value. For example, if the measured change in the drawn current exceeds the threshold current value, the processor 452 can decide to perform one or more actions on the computing device.

For example, when the computing device 450 detects the proximity of the user to the keyboard assembly 410, the computing device 450 can activate the backlighting 470.

In another example, when the computing device 450 detects the proximity of the user to the keyboard assembly 410, the computing device 450 can activate a first microphone 464 and a second microphone 466. The first microphone 464 and the second microphone 466 can be operatively coupled (connected) to a microphone controller 462. The microphone controller 462 can use a signal detected by the first microphone 464 to suppress dynamic noise in a signal detected by the second microphone 466. For example, the first microphone 464 can be located close to a source of dynamic noise (e.g., mechanical keys of a keyboard (e.g., the key set 320 in FIG. 3)) to detect the presence of a dynamic noise (e.g., noise associated with the press of a key of the keyboard). The first microphone 464 can generate a signal indicative of the occurrence of a dynamic noise event. Then, in response to the signal, a dynamic audio signal filter 468 can be triggered to suppress the dynamic noise in a signal that is detected by the second microphone 466. For example, the dynamic audio signal filter 468 can suppress the noise associated with the pressing of keys on a keyboard in the signal detected by the second microphone 466 (e.g., a user speaking into the second microphone 466). This noise cancellation process is described in U.S. patent application Ser. No. 13/930,008 entitled “Microphone Under Keyboard to Assist in Noise Cancellation”, the entire contents of which are incorporated by reference.

A steady-state condition for the plurality of interconnected sensor electrodes can be when a conductive object (e.g., a human body part (e.g., a hand of a user) is not in proximity to any of the sensor electrodes. The amount of current drawn through the plurality of interconnected sensor electrodes by the sensor controller 458 during the steady-state condition (a steady-state current value) can be very small (e.g., less than 100 microamperes). As such, the computing device 450 can be placed in a low power mode (e.g., a sleep state, a hibernate state) while keeping the sensor controller 458 active, enabling proximity detection of a conductive object to the sensors 404 even when the computing device 450 is in a low power mode.

The computing device 450 can be in a low power mode when the computing device 450 detects the proximity of the user to the keyboard assembly 410. Based on the detected proximity of the user, the computing device 450 can “wake up” and transition from the low power mode to a full power mode (e.g., keyboard backlighting is enabled, the display 454 is at full brightness, the first microphone 464 and the second microphone 466 are enabled).

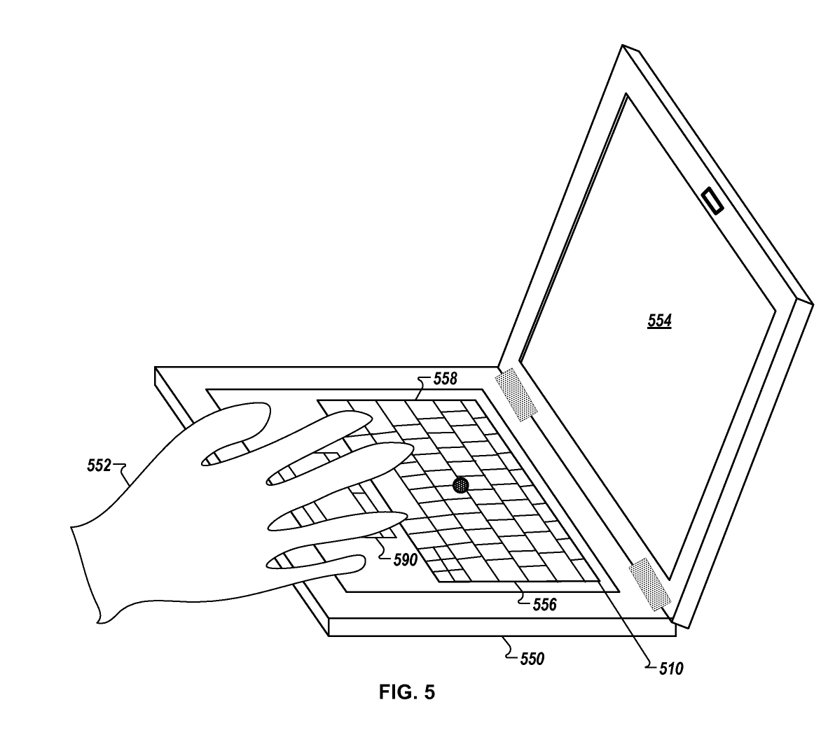

FIG. 5 is a diagram that illustrates an example of a user interacting with a computing device 550. In the example in FIG. 5, a keyboard assembly 510 can include a touchpad 590 with mouse buttons. For example, a hand 552 of a user can hover over the keyboard assembly 510. As described with reference to FIGS. 1A-B and FIG. 4, interconnected sensor electrodes included in a membrane keyboard included in the keyboard assembly 510 can emanate electric fields through a key set. The proximity of the hand of the user is detected when the computing device 550 determines that a change in the measured current drawn through the interconnected sensor electrodes is above a threshold level.

In some implementations, proximity can be detected when a hand of a user is at a position that is approximately fifteen or less centimeters from the keyboard. For example, a hand of a user may hover over the keyboard and proximity of the hand can be detected when the hand is hovering at fifteen or less centimeters from the keyboard. In some implementations, proximity can be detected when a hand of a user is at a position that is approximately eight or less centimeters from the keyboard. For example, a hand of a user may hover over the keyboard and proximity of the hand can be detected when the hand is hovering at eight or less centimeters from the keyboard. Referring to FIG. 4, the position of detected proximity can be dependent on the sensitivity of the sensor controller 458. The greater the sensitivity of the sensor controller 458, the farther the detected position of a conductive object to the keyboard.

The threshold level can be determined based on a distance between the detected conductive object (e.g., the hand 552 of the user) and the keyboard assembly 510. For example, the computing device 550 can detect the proximity of the conductive object when it less than a particular distance above the keyboard assembly 510 (e.g., less than three inches, less than six inches). The threshold level value can be determined based on a difference between a steady-state current value and a measured current drawn through the interconnected sensor electrodes when a conductive object is located at the particular distance above the keyboard assembly 510.

In some implementations, as described with reference to FIGS. 1A-B and FIG. 3, a first subset of a plurality of interconnected sensor electrodes can define an area or zone of the membrane keyboard (e.g., a left half 558 (left side) of the keyboard assembly 510) and a second subset of the plurality of interconnected sensor electrodes can define another area or zone of the membrane keyboard (e.g., a right half 556 (right side) of the keyboard assembly 510). The computing device 550 can separately detect proximity of a hand of a user with the left half 558 of the keyboard assembly 510 and can detect the proximity of a hand of a user with the right half 556 of the keyboard assembly 510. The computing device 550 can use this proximity information to detect the movement of the hand of the user across the keyboard assembly 510. The movement can be detected as a gesture of the user when interacting with an application running on the computing device 550 (e.g., turning the page of a document displayed in a display area 554 of the computing device 550).

Though two zones are described, a plurality of interconnected sensor electrodes can be grouped into more than two zones. The zones can each detect proximity of a conductive object.

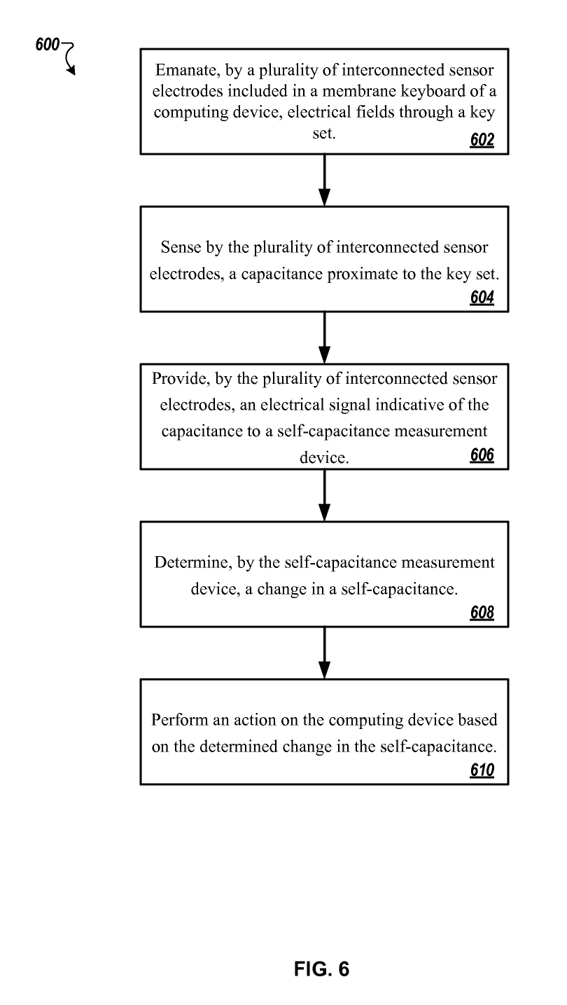

FIG. 6 is a flowchart that illustrates a method 600 of detecting proximity to a computer device. In some implementations, the computing devices described herein can implement the method 600.

The method 600 begins by a plurality of interconnected sensor electrodes, included in a membrane keyboard of a computing device, emanating electrical fields through a key set (block 602). For example, the electrical fields can emanate from the plurality of interconnected sensor electrodes through a key set that overlays the membrane keyboard. The key set and the membrane keyboard can be included in a keyboard assembly for the computing device as shown in FIG. 3, for example.

A capacitance proximate to the key set is sensed by the plurality of interconnected sensor electrodes (block 604). For example, a hand of a user (a conductive object) is hovering over a keyboard assembly. The proximity of the hand of the user to the keyboard assembly is sensed by the plurality of interconnected sensor electrodes. For example, when the hand of the user is near one or more of the interconnected sensor electrodes, the capacitance of the human body changes the self-capacitance of the proximate sensor electrodes, changing the self-capacitance of the plurality of interconnected sensor electrodes. The current drawn by the plurality of interconnected sensor electrodes when the hand of the user is near one or more of the interconnected sensor electrodes is greater than a steady-state current value measured when no conductive object (e.g., the hand of the user) is proximate to any of the plurality of interconnected sensor electrodes.

The plurality of interconnected sensor electrodes provide an electrical signal indicative of the capacitance to a self-capacitance measurement device (block 606). For example, the plurality of interconnected sensor electrodes can provide a signal indicative of the value of the current drawn by the plurality of interconnected sensor electrodes when the hand of the user is near one or more of the interconnected sensor electrodes to the self-capacitance measurement device included in the computing device

The self-capacitance measurement device determines a change in a self-capacitance (block 608). For example, the self-capacitance measurement device can determine that the value of the current drawn by the plurality of interconnected sensor electrodes when the hand of the user is near one or more of the interconnected sensor electrodes is greater than a steady-state current value that is measured when no conductive object (e.g., the hand of the user) is proximate to any of the plurality of interconnected sensor electrodes. The self-capacitance measurement device can provide a value for a difference in the current drawn by the interconnected sensor electrodes to a processor included in the computing device.

An action on the computing device based on the determined change in the self-capacitance is performed (block 610). For example, the processor can determine that the change in the self-capacitance of the plurality of interconnected sensor electrodes (the value of the difference in the current drawn by the interconnected sensor electrodes) is indicative of the proximity of a human body part (e.g., the hand of the user) with the keyboard assembly. The processor can make this determination based on, for example, the value of the difference in the drawn current being greater than a threshold value. The processor can decide to perform an action on the computing device based on the value of the difference in the drawn current being greater than the threshold value. The actions can include, but are not limited to, turning on or enabling keyboard backlighting, turning on or enabling one or more microphones (e.g., for use in keyclick noise removal), and power mode transitioning (e.g., from a low power mode (e.g., a sleep mode, a hibernate mode) to a full power mode.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device (computer-readable medium, a non-transitory computer-readable storage medium, a tangible computer-readable storage medium) or in a propagated signal, for processing by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the processing of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A system comprising:
a key set including a plurality of keys;
a membrane keyboard including a plurality of key pads and a plurality of interconnected sensor electrodes, wherein at least one of the plurality of key pads corresponds to a one of the plurality of keys; and
a feature plate that provides a rigid backing for the membrane keyboard.

2. The system of claim 1, wherein the membrane keyboard is coupled to the feature plate.

3. The system of claim 1, wherein electric fields emanate from the plurality of sensor electrodes through the key set.

4. The system of claim 3, wherein electric fields emanate from a plurality of runs connecting the plurality of sensor electrodes.

5. The system of claim 3, wherein the plurality of interconnected sensor electrodes detect a proximity of a conductive object with the system by sensing a capacitance of the object.

6. The system of claim 5, wherein the conductive object is a human body part.

7. The system of claim 6, wherein the human body part is a hand.

8. A computing device comprising:
a key set;
a membrane keyboard including a plurality of interconnected sensor electrodes;
a self-capacitance measurement device;
a non-transitory computer-readable medium having instructions stored thereon, the instructions, when executed by a processor, causing at least one processor of the computing device to perform operations comprising:
emanating, by the plurality of interconnected sensor electrodes, electrical fields through the key set;
sensing, by the plurality of interconnected sensor electrodes, a capacitance;
providing, by the plurality of interconnected sensor electrodes, an electrical signal indicative of the sensed capacitance to the self-capacitance measurement device;
determining, by the self-capacitance measurement device, a change in a self-capacitance; and
performing an action on the computing device based on the determined change in the self-capacitance.

9. The computing device of claim 8, wherein sensing, by the plurality of interconnected sensor electrodes, a capacitance comprises sensing the capacitance of a part of a human body.

10. The computing device of claim 9, wherein the part of the human body is a hand.

11. The computing device of claim 8, wherein performing an action on the computing device comprises activating keyboard backlighting.

12. The computing device of claim 8, wherein performing an action on the computing device comprises activating a microphone.

13. The computing device of claim 8, wherein performing an action on the computing device comprises transitioning the computing device from a sleep or reduced power mode to a full power mode.

14. The computing device of claim 8, further comprising:
a feature plate coupled to the membrane keyboard; and
a chassis, wherein the feature plate is not grounded to the chassis.

15. A method comprising:
emanating, by a plurality of interconnected sensor electrodes included in a membrane keyboard of a computing device, electrical fields through a key set;
sensing, by the plurality of interconnected sensor electrodes, a capacitance proximate to the key set;
providing, by the plurality of interconnected sensor electrodes, an electrical signal indicative of the capacitance to a self-capacitance measurement device;
determining, by the self-capacitance measurement device, a change in a self-capacitance; and
performing an action on the computing device based on the determined change in the self-capacitance.

16. The method of claim 15, wherein sensing, by the plurality of interconnected sensor electrodes, a capacitance comprises sensing the capacitance of a part of a human body.

17. The method of claim 16, wherein the part of the human body is a hand.

18. The method of claim 15, wherein the action performed on the computing device comprises activating keyboard backlighting.

19. The method of claim 15, wherein the action performed on the computing device comprises activating a microphone.

20. The method of claim 15, wherein the action performed on the computing device transitions the computing device from a sleep or reduced power mode to a full power mode.
